(19) United States
(12) Patent Application Publication
(10) Pub. No.: US 2008/0122932 A1
(43) Pub. Date: May 29, 2008

(54) REMOTE VIDEO MONITORING SYSTEMS UTILIZING OUTBOUND LIMITED COMMUNICATION PROTOCOLS

(76) Inventors: George Aaron Kibbie, Draper, UT (US); Daniel David Bowen, West Jordan, UT (US); Glenn Daniel Clapp, Sandy, UT (US); Jeremy Noring, Corvallis, OR (US)

Correspondence Address: BAKER & ASSOCIATES PLLC, 470 EAST NINTH AVENUE, SALT LAKE CITY, UT, 84103, US

(21) Appl. No.: 11/941,825

(22) Filed: Nov. 16, 2007

Related U.S. Application Data
(60) Provisional application No. 60/867,425, filed on Nov. 28, 2006.

(51) Int. Cl. H04N 7/18; H04N 5/225; H04M 1/66; H04Q 7/20

(52) U.S. Cl. 348/159; 348/207.1; 455/466; 455/411; 348/E07.085; 348/E07.086; 348/E07.088

(57) ABSTRACT

One embodiment of the present invention relates to a computer based remote video monitoring system including a set of video input sources, a control module, and a client module. The video input sources are coupled to the control module via a local data transmission system such as a local area network. The client module is indirectly data coupled to the control module through an intermediary data server via a global data transmission system such as the Internet. The indirect data coupling between the client module and the control module is limited to an outbound data limited communication protocol such as an instant messaging protocol specifically including the messaging and presence protocol XMPP. The indirect data coupling enables the client module to perform various video monitoring system management related functions including controlling the control module so as to effect the video data signals produced by the video input sources.

### RELATED APPLICATIONS

This application claims priority to U.S. provisional application Ser. No. 60/867,425 filed Nov. 28, 2006, the contents of which are incorporated by reference.

### FIELD OF THE INVENTION

The invention relates to remote video monitoring systems. In particular, the invention relates to systems and methods for remotely controlling aspects of a video monitoring system utilizing outbound limited communication protocols.

### BACKGROUND OF THE INVENTION

Video monitoring systems are used to monitor video signals from one or more discrete locations or view angles. These systems are often used for security, surveillance, and personnel performance monitoring. Video monitoring systems generally include video capture devices, a control device, and a display. The video capture devices are one or more cameras configured to record video data at particular discrete locations. The control device is a computer or electronic module that receives the video data from each of the video capture devices and routes the signal to the display. The display converts the video data into a visually identifiable format. These components may be embedded into a personal computer or digital computer network, or they may incorporate portions of a computer network for purposes of data transmission and/or display.

Users of a video monitoring system may wish to display and affect aspects of the system from a remote location that is not necessarily within the scope of the local data transmission system used to transfer video data from the video capture devices to the control device. Therefore, the control device may also be coupled to a wide area network (WAN) or global network for purposes of remote data viewing and system manipulation. Remote data viewing includes viewing video output data from the video system. System manipulation includes any type of action that affects or controls the data produced by the video monitoring system. For example, a remote user may view video data from one of the video capture devices on a remote computer or handheld video display device that is data coupled to the Internet. Likewise, a remote user may engage/disengage a feature that affects the video output of the video monitoring system from a remote device such as a computer or handheld video display device.

However, some of the challenges associated with remotely affecting, controlling, or manipulating a local video monitoring system are the communication speed, complex data routing, and connection logistics commonly required for communication of necessary data between the remote device and the local video monitoring system. Remote users are often data coupled via less than ideal data systems, causing slow transmission and receipt of data packets. Conventional remote manipulation systems also require the remote device to be pre-coupled to the local system, requiring an inefficient authentication and connection process before any data is transmitted. Likewise, conventional remote device control systems utilize complex inefficient data encoding so as to facilitate the creation of control type task requests. Many of these limitations are prescribed by industry standards designed to enable compatibility among video monitoring systems and components.

Therefore, there is a need in the video data monitoring industry for a control system or scheme that enables efficient communication between a remote user and a local video monitoring system.

### SUMMARY OF THE INVENTION

The present invention relates to systems and methods for remotely controlling aspects of a video monitoring system utilizing outbound limited communication protocols. One embodiment of the present invention relates to a computer based remote video monitoring system including a set of video input sources, a control module, and a client module. The video input sources are coupled to the control module via a local data transmission system such as a local area network. The client module is indirectly data coupled to the control module through an intermediary data server via a global data transmission system such as the Internet. The indirect data coupling between the client module and the control module is limited to an outbound data limited communication protocol such as an instant messaging protocol specifically including the messaging and presence protocol XMPP. The indirect data coupling enables the client module to perform various video monitoring system management related functions including controlling the control module so as to effect the video data signals produced by the video input sources. A second embodiment of the present invention relates to a method for facilitating an indirect data coupling between a video monitoring system control module and a remote client module. The method includes receiving one-way data communications from both the control module and the client module and initiating an outbound data limited coupling therebetween. Various communications are then received and transmitted from/to the control module and client module including requests, request responses, notifications, etc.

Embodiments of the present invention represent a significant advance in efficient data coupling between video monitoring systems and remote client modules. Outbound data limited communications are significantly more efficient than traditional two-way data communications for a variety of reasons. First, outbound data limited communications require less bandwidth to transmit and therefore are able to be transmitted on low bandwidth or high occupancy transmission systems. Second, outbound data limited communications are able to efficiently circumvent various types of security precautions that may otherwise impede traditional two-way data communications. Third, outbound data limited communications do not require the conventional authentication or response sequences within each communication, thereby further increasing efficiency.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular rather than complete portions of the systems and methods of making and using the system according to the invention. In the Figures, the physical dimensions may be exaggerated for clarity.

FIG. 1 illustrates a flow chart of a suitable computer operating environment for embodiments of the present invention;

FIG. 2 illustrates a schematic view of a computer-controlled, distributed multiple video monitoring system including a first system embodiment of the present invention;

FIG. 3 illustrates a communication chart detailing outbound data limited communications between a control module, intermediary data server, and remote client in accordance with embodiments of the present invention; and

FIG. 4 illustrates a flow chart of a method for facilitating an outbound data limited communication between a control module and remote client module in accordance with a second embodiment of the present invention.

### DETAILED DESCRIPTION OF THE INVENTION

The present invention relates to systems and methods for remotely controlling aspects of a video monitoring system utilizing outbound limited communication protocols. One embodiment of the present invention relates to a computer based remote video monitoring system including a set of video input sources, a control module, and a client module. The video input sources are coupled to the control module via a local data transmission system such as a local area network. The client module is indirectly data coupled to the control module through an intermediary data server via a global data transmission system such as the Internet. The indirect data coupling between the client module and the control module is limited to an outbound data limited communication protocol such as an instant messaging protocol specifically including the messaging and presence protocol XMPP. The indirect data coupling enables the client module to perform various video monitoring system management related functions including controlling the control module so as to effect the video data signals produced by the video input sources. A second embodiment of the present invention relates to a method for facilitating an indirect data coupling between a video monitoring system control module and a remote client module. The method includes receiving one-way data communications from both the control module and the client module and initiating an outbound data limited coupling therebetween. Various communications are then received and transmitted from/to the control module and client module including requests, request responses, notifications, etc. While embodiments of present invention are described in reference to a video monitoring system, it will be appreciated that the teachings of present invention are applicable to other areas.

The following terms are defined as follows:

Video monitoring system—a system for location-based monitoring for purposes including surveillance, monitoring, and personnel performance.

Local data transmission system—a data transmission system for transferring data between components within a confined region. Examples are a local area network, Ethernet network, power line computer network, wireless network, analog and/or digital wired or wireless transmission systems.

Global data transmission system—a data transmission system for transferring data between distributed components within a geographically large area. For example, the Internet enables data transmission between distributed components. A global data transmission system is defined broadly to include a local data transmission system.

Control module—a computer and/or electrical component in a video monitoring system for purposes including receiving, transmitting, displaying multi-location video data, compositing video from multiple sources, and/or communicating with remote clients. In a video monitoring system, a control module may be coupled to one or more video input sources within a local data transmission system.

Client module—a computer and/or electrical component that is configured to enable a user to view video data. A client module may be a remote client module meaning that it is data coupled to view the video data across a global data transmission system such as the Internet. Alternatively or in addition, a client module may be local client, meaning that it is coupled to a control module via the local data transmission system. In addition, the client module may include either a specific video monitoring system software module and/or a web browser for facilitating communication within a video monitoring system.

Video data signal—a stream of graphical video data capturing time based sequential images of a particular location.

Video capture device—a device configured to capture and generate a video data signal. A video data signal may be produced by either an analog or digital video capture device.

Multi-use personal computer—a computing device that is used for a multitude of purposes including that which is specified. For example, a personal computer is routinely used to perform numerous distinct tasks including personal Internet browsing, accounting, and the like.

Indirect data coupling—a data coupling between two elements in which all communications are routed through a particular third element to facilitate/manage the data coupling.

Intermediary data server—a data server or processing element facilitating an indirect data coupling between two elements in a video monitoring system.

Outbound data limited communication protocol—a protocol in which all originating communications are based on one way data transmissions.

Instant messaging protocol—a type of outbound data limited protocol in which data is packaged in a particular manner. One example of an Instant messaging protocol is XMPP.

Intermediary data server—a server that is disposed between two elements, wherein the intermediary data server receives and transmits data from one element to another. Therefore, the two communication elements are indirectly data coupled via the intermediary data server. In addition, an intermediary data server may establish and/or broker a peer-to-peer data coupling between two communication points for more efficient data transfer. These types of peer-to-peer and indirect data coupling facilitate the use of outbound limited communication protocols such as XMPP.

The following disclosure of the present invention is grouped into two subheadings, namely “Operating Environment” and “Remote Video Monitoring System”. The utilization of the subheadings is for convenience of the reader only and is not to be construed as limiting in any sense.

### Operating Environment

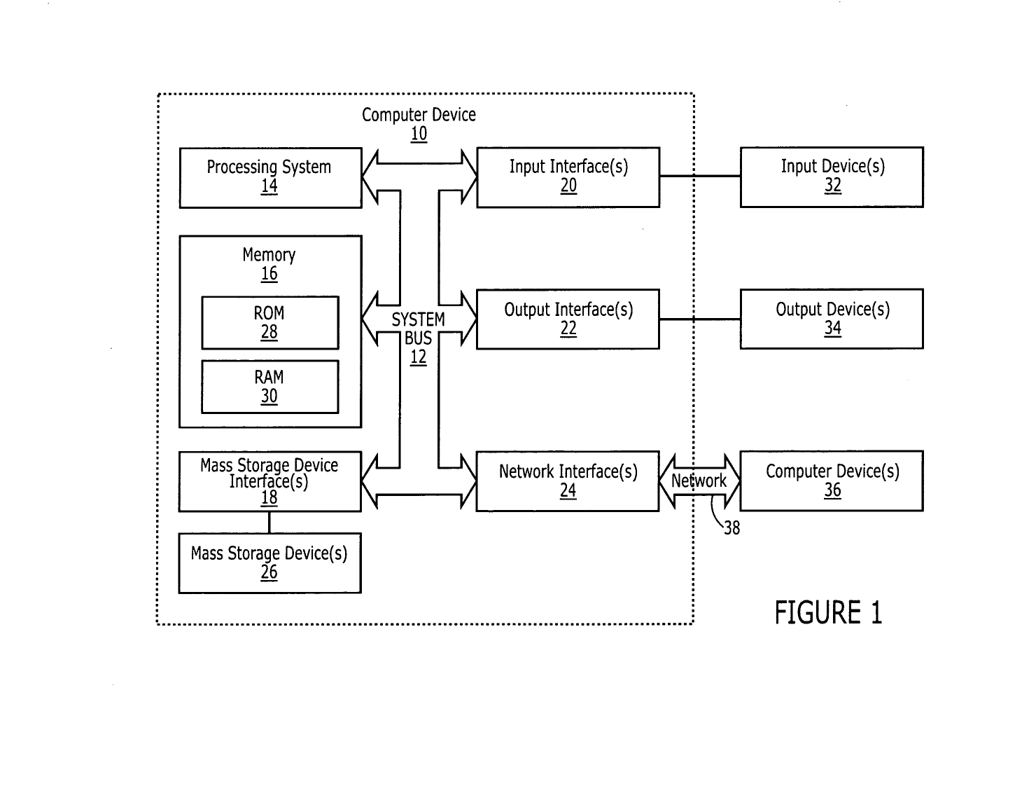

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”), smart phone, or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Remote Video Monitoring System

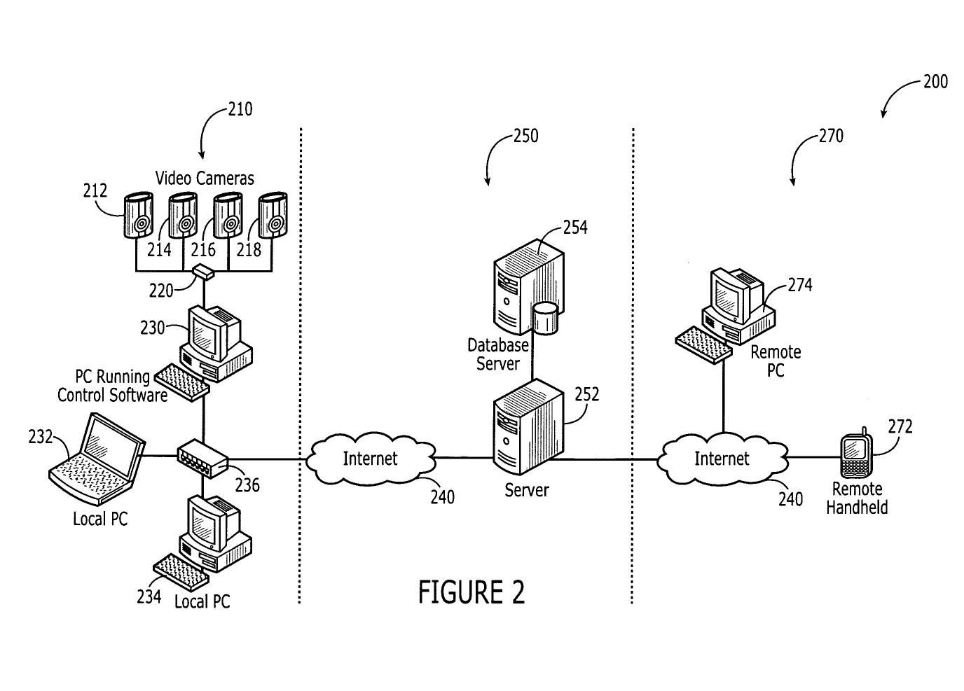

Reference is next made to FIG. 2, which illustrates a schematic view of a computer-controlled, distributed multiple video monitoring system, designated generally at 200. The illustrated system 200 architecture is an example of one type of video monitoring system in which embodiments of the present invention may be utilized. Various components of the illustrated system will be further described for purposes of reference to the embodiments of the present invention. It will be appreciated that embodiments of the present invention may be utilized with other alternative distributed video monitoring system architectures. The illustrated system 200 includes a local computer-controlled video monitoring/surveillance system 210, a distributed data processing system 250, and a remote client system 270. The systems 210, 250, 270 are coupled via the Internet 240, which acts as a global data transmission system. As is well known in the industry, various components may be further distributed or geographically consolidated for purposes of utilizing hardware and/or data coupling resources.

The computer-controlled video monitoring system 210 includes a plurality of video capture devices 212, 214, 216, 218, a video router 220, a control module 230, a local laptop client 232, a local pc client 234, and a local network router 236. The video capture devices 212, 214, 216, 218 are digital video cameras configured to capture video data of a particular location and generate a video data signal that includes graphical sequential images of the particular location. One type of digital video capture device is a WILFE® brand camera. The video capture devices 212, 214, 216, 218 are data coupled to the control module 230 via a video router 220. The video router 220 is an optional component and may be any type of data converter, multiplexer, or router such as a USB power line data converter or Ethernet data converter. For example, the video capture devices 212, 214, 216, 218 may be coupled to a power line network such as a HOMEPLUG type system in which a USB data converter allows the control module 230 to receive the video data signal from all of the video capture devices 212, 214, 216, 218 across the power line. The video capture devices 212, 214, 216, 218 may include a variety of different types of devices including but not limited to analog, digital, wireless, wired, panable, fixed, indoor, outdoor, discrete, spy, mobile, etc. The control module 230 is a multi-use personal computer running a software module configured to receive and process the video data signals from the video capture devices 212, 214, 216, 218. For example, the software module may be a WILIFE® brand program. The control module 230 may perform other tasks in addition to managing the video data signals utilizing a well known multiprocessing operating system such as Microsoft WINDOWS®. The control module 230 may be configured to record, display, alert, or transmit data corresponding to the video data signals from the video capture devices 212, 214, 216, 218. The local laptop client 232 and local PC client 234 are data coupled to the control module 230 via an optional network router 236 such as an Ethernet wired router or wireless 802.11 type data router. Various other local network architectures may be utilized to distribute the video data signals among the local clients 232, 234 and between the video capture devices 212, 214, 216, 218, and the control module 230.

The computer-controlled video monitoring system 210 is coupled to the distributed data processing system 250 via the Internet 240. The distributed data processing system 250 includes a database server 254 and a server 252. The database server 254 may be configured to store video data from one or more computer controlled video monitoring systems 210, authentication information, account information, etc. The server 252 may be used to facilitate routing video data from the computer controlled video monitoring system 210 to the remote client system 270. For example, the illustrated server 252 and database server 254 may authenticate a user on the remote client system 270 and transmit the appropriate one or more requested video data signals from the corresponding computer-controlled video monitoring system 210. Various other management and storage type functions may be performed by the distributed data processing system 250. In an alternative data processing configuration, data signals from the computer controlled video monitoring system 210 may be routed directly to the remote client system 270 without the data processing system 250. Depending on various communication parameters, the use of intermediary data routing, authentication, and/or processing through the distributed data processing system 250 is optional.

The remote client system 270 includes a remote client PC 274 and a remote client handheld 272, both data coupled to the Internet 240. The remote clients 272, 274 may display one or more video data signals from the video capture devices 212, 214, 216, 218 of the computer controlled video monitoring system 210. In particular, the remote clients 272, 274 may select to view the multiple video data signals individually, simultaneously, or intermittently. The remote clients 272, 274 may also interface with the distributed data processing system 250 for purposes of authentication, data routing, electronic payment, management, etc. The remote clients 272, 274 may be coupled to the Internet 240 utilizing various well known connection schemes, including but not limited to cellular phone data networks, local computing data networks, etc. The remote clients 272, 274 may interface and/or receive the video data signals from a web browser or directly within a particular local software module. Likewise, the remote clients 272, 274 may receive email attachments corresponding to data from the computer controlled video monitoring system 210.

With continued reference to FIG. 2, a similar architecture may be implemented for use in accordance with embodiments of the present invention relating to a computer based remote video monitoring system in which a client module is able to perform control functionality that affects one or more video data signals. In accordance with embodiments of the present invention, control related communications between a client module and the control module are limited to outbound data communications. The indirect data communication creates an indirect data coupling between one or more of the clients and the control module 230. The indirect data communications includes utilizing an outbound data limited communication protocol for transmitting data. In particular, an outbound data limited communication protocol includes an instant messaging protocol, for example the XMPP protocol. Examples of specific outbound data limited communication sequences are further described with reference to the subsequent Figures. All client module control communication with the control module are therefore initiated as an outbound communication from either the control module 330 to the intermediary data server 252 or from a client module 232, 234, 274, 272 to the intermediary data server 252. These outbound communications between the client modules, intermediary data server 252, and control module 230 do not require conventional 2-way authentication or response, thereby greatly increasing efficiency. Likewise, this type of outbound limited communication enables a wide variety of clients, including but not limited to web browsers, web applications, clients coupled to the local data transmission system of the control module, and clients coupled to the global data transmission system. It will be appreciated that various formats of outbound data limited communications may be utilized in accordance with embodiments of the present invention.

The illustrated server 252 may also be referred to as an intermediary data server 252 for purposes of managing indirect data communications between the control module 230 and a client module. The intermediary data server 252 may be an XMPP dedicated server and include various other components such as a web server (not shown) for facilitating indirect data communications between the control module 230 and a client module over a web interface. Likewise, the database server 254 may be utilized in authenticating, encrypting and/or initiating indirect data couplings between the control module 230 and a client module. It will be appreciated that a single intermediary data server 252 may indirectly couple multiple control modules and client modules.

As described in general above, the control module 230 is coupled to a plurality of video input sources including corresponding video data signals via a local data transmission system such as a local area network of the type illustrated. The software module utilized by the control module 230 for managing the video input sources may also facilitate transmitting and receiving the outbound data limited communications with the intermediary data server 252.

A client module is indirectly coupled to the control module 230 through the intermediary data server 252 to facilitate the ability to performance control functions that effect one or more of the data signals. The client module may include various remote and locally disposed computing and electronic devices utilizing various interfaces such as a dedicated video monitoring system software module or a web interface. For example, a client module may be referred to as “remote” such as the components of the remote client system 270, remote PC 274 and/or remote handheld 272 in that they are coupled to the intermediary data server 252 via the global data transmission system 240. Likewise, a client module may be referred to as “local” such as a local PC 232, 234. These types of local client modules 232, 234 may also be indirectly data coupled to the control module 230 and referred to as “remote” even though they are directly data coupled to the control module 230 as part of the illustrated local area network. The indirect data coupling of the local client modules 232, 234 includes indirect routing of all data communications through the intermediary data server 252 via the Internet 240 rather than directly through the local area network. In addition, client modules may transmit and receive outbound data limited protocols through a dedicated video monitoring software module or through a web interface.

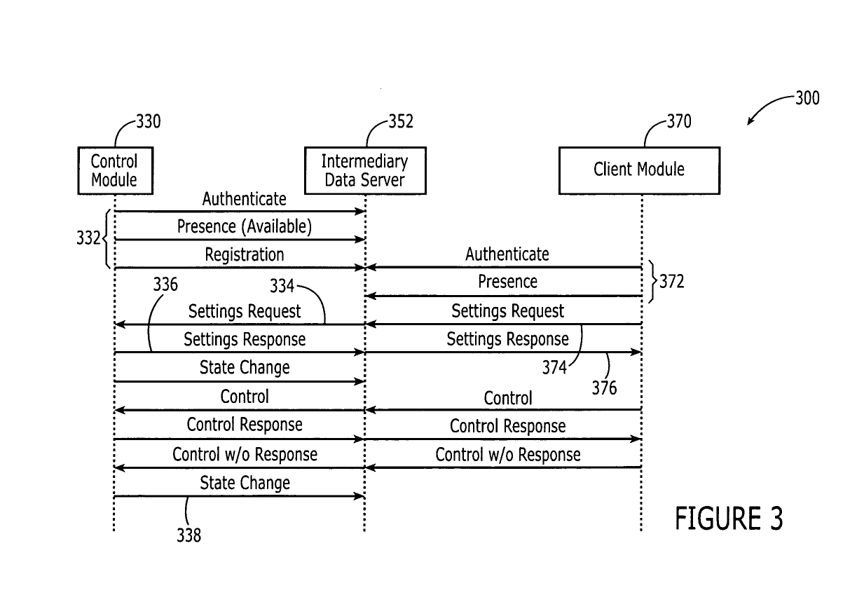

Reference is next made to FIG. 3, which illustrates a communication chart detailing typical remote control communications between elements of a remote video monitoring system in accordance with embodiments of the present invention, designated generally at 300. The illustrated communication schematic 300 includes a control module 330, an intermediary data server 352, and a client module 370. Various examples of outbound data limited communications are illustrated for use in a video monitoring system. It will be appreciated that alternative outbound data limited communication sequence formats may be utilized to accomplish similar functionality in accordance with alternative embodiments of the present invention. The control module 330 transmits a one-way control module initiation 332 data communication to the intermediary data server 352 to facilitate registering for an indirect data coupling with various client modules 370. The control module initiation 332 may include authentication, presence, and registration information. Likewise, the client module 370 will transmit a one-way client module initiation 372 to facilitate registering for an indirect data coupling with a control module 330. The client module initiation 372 may include authentication and presence. The intermediary data server 352 receives the control module initiation 332 and client module initiation 372 and determines if the initiations 332, 372 are properly corresponding to one another. Various corresponding and comparison data mathematical algorithms may be used to determine if the initiations 332, 372 correspond to one another. If it is determined that the initiations 332, 372 properly correspond, the intermediary data server 352 initiates an outbound data limited coupling between the control module 330 and the client module 370, which includes brokering various one-way data communications illustrated below the initiation s 332, 372.

One type of outbound data limited communication between the client module 370 and the control module 330 includes a request and request response sequence. For example, the client module 370 may transmit a request 374 to the intermediary data server 352, which then transmits a corresponding request 334 to the control module 330. The control module 330 may then perform some type of control related operation based on the data content of the request 374, 334 such as a video capture device settings change. Various specific examples of requests and corresponding operations will be described below as Appendix A. After the control module 330 performs the operation relating to the request 374, 334, the control module may transmit a request response 336 to the intermediary data server 352, which then transmits a corresponding request response 376 to the client module 370. In this manner, all communications between the client module 370 and the control module 330 are limited to outbound data and/or one-way communications requiring less bandwidth and less authentication, and they are thus able to circumvent security systems. Request and response sequences may include but are not limited to settings retrieval, setting change, setting update, control, video playback, video stream selection, video state selection, messaging, asset inventory, asset search, file transfer, stream request/termination, and skip to next file/camera. These specific types of request and request response sequences will be described in more detail below in reference to Appendix A. Various other types of one-way communications may be utilized, including but not limited to notifications. Notification sequences may include but are not limited to state change notification, presence, advertising, motion detected, recording status, stream status, alert notification, etc. These specific types of notification sequences will be described in more detail below in reference to Appendix A. Some one-way communications may only be transmitted to the intermediary data server 352 rather than brokered such as a state change notification 338.

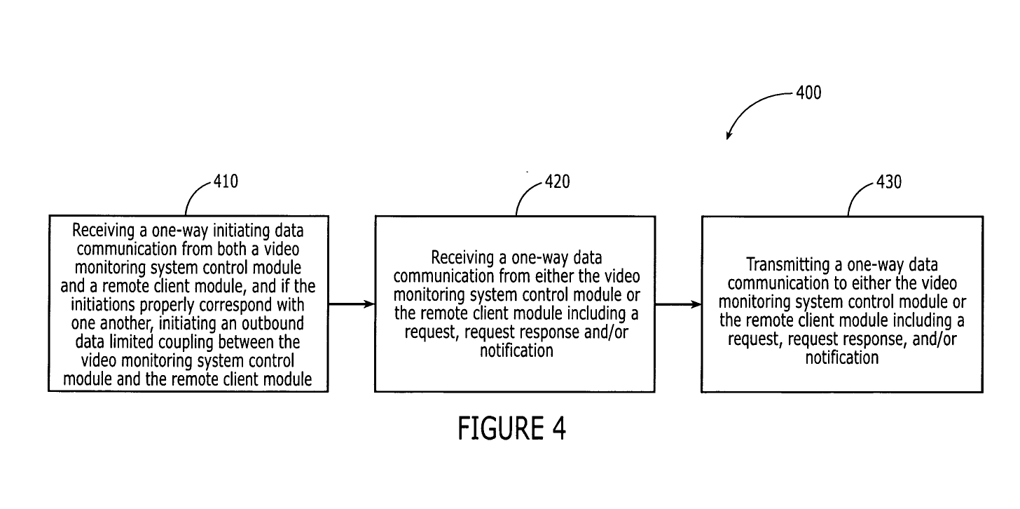

Reference is next made to FIG. 4, which illustrates a flow chart of a method for facilitating an outbound data limited communication between a video monitoring system control module and remote client module, designated generally at 400. The method may be practiced by an intermediary data server of the type illustrated in FIGS. 2 and 3 of the present application. Initially, one-way data initiation sequences are received from both a control module and remote client module and if the initiations properly correspond, there is initiation of an outbound data limited coupling between the video monitoring system control module and the remote client module, act 410. A one-way data communication may subsequently be received from either the video monitoring system control module or the remote client module, including a request, request response, and/or notification, act 420. A one way data communication may then be subsequently transmitted to either the video monitoring system control module or the remote client module including a request, request response, and/or notification, act 430.

Various other embodiments have been contemplated including combinations in whole or in part of the embodiments described above.

### Appendix A

The following types of one-way/outbound data limited communication sequences for use with a specific WILIFE® type video monitoring system including a software module functioning as part of a control module referred to as WILIFE® Command Center™. The following communication and sequence types are described in more detail for purposes of explanation and best mode:

1. State Change Notification

Indicates to a remote client that the software or one of its components or devices has undergone some sort of state change, such as recording, motion, offline, or online among others.

2. Presence of the System or Any or All Components of the System

A sub-set of state change and specifically the online or offline status of the software or one of its components, or a device.

3. Video Playback Control and Video Stream Selection and State

Any form of message that for providing video control. This includes specifying a desired source, play, pause, skip forward, skip back, and other forms of video source selection, format control, or transport control.

4. Advertising and Marketing

Messages sent from the back-end to WILIFE® Command Center or other client software providing suggestions, tips, offers, help, coupons, product announcements and information or any other form of solicited or unsolicited promotional or advice messages.

5. Messaging

Messaging allows one client to send free-form text or other types of content to another endpoint. Such messages include chat, state changes, information, user-provided data and system provided data.

6. Settings Retrieval, Change, and Update

A form of message involving a “Get” request to request specific configuration or settings data, such as a device name or overall device configuration. This data is returned to the requester. These settings can then be examined or changed by the requesting endpoint, and then sent back to the source endpoint via “Set” message. “Get” and “Set” are generic terms and are not meant to specify specific “Get” or “Set” message types.

7. Asset Inventory

A form of “Get” that requests configuration and device connection information from an endpoint. This may also be provided as a form unsolicited presence information as described above. Asset inventory may also include information about subscription plans, activations, and capabilities.

8. Asset Search

A set of messages and packets that request remote assets such as video files based on simple or complex search criteria. Messages include the number of result “hits” and paging information allowing the requesting endpoint to request result sets in blocks. For example, if the search indicates that there are 1000 items in the result set, the requesting endpoint can request page 60 of the result set with 25 items per page. The search messages also include sort criteria wherein changing the sort criteria may return different results for a particular “page” of the result set with N items per page.

9. File and Data Transfer Between Endpoints or Endpoint and Server

A set of messages for an endpoint to request that the server or another endpoint accept a file transmission (or other source of binary or other data type), receive permission to proceed, transmit the file in one to N chunks of data, receive acknowledgement of the data received, and for the receiving endpoint to verify, validate, and process the resulting data transmission. Processing may involve any form of parsing, conversion, or storage.

10. Motion Detected

A form of State Change notification that is an unsolicited message to one or more subscribing endpoints when a device in WILIFE® Command Center detects motion.

11. Recording Stopped or Started

A form of State Change notification that is an unsolicited message to one or more subscribing endpoints when WILIFE® Command Center begins to record video or concludes recording video.

12. Stream Ready or Stream Ended

A set of messages, solicited or unsolicited that indicate to the requesting or subscribing endpoints that WILIFE® Command Center is ready to accept a connection for a video stream or has begun to serve video to a video server or other video endpoint or intermediary. Stream ended is an unsolicited message indicating that WILIFE® Command Center has concluded streaming and will no longer accept a connection from a video streaming endpoint or is no longer providing a video stream to a video streaming endpoint or server.

13. Stream Requests and Stream Terminations

A stream request is a message from a video streaming endpoint or other endpoint that is requesting that WILIFE® Command Center provide a video stream either directly to a video streaming endpoint or intermediary video server. These streams may be pushed from WILIFE® Command Center or pulled by the video client. Stream termination is a message to WILIFE® Command Center to indicate that a stream is no longer required and WILIFE® Command Center may terminate any video streaming activity.

14. Skip to Next File or Camera in a Stream

15. Alert Sent

An unsolicited message sent by WILIFE® Command Center to any subscribing endpoint indicating that a motion or other form of alert message has been sent. For example, when a Wilife camera detects motion and has sent an e-mail or SMS alert message informing the owner that a camera detected motion, WILIFE® Command Center may also send a data packet to a subscribing client system informing that an alert e-mail or SMS message has been sent to particular addresses or devices. The WILIFE® Command Center services also support connection alerts to inform a user that the WILIFE® Command Center software or one or more cameras have come online or gone offline. A data packet may be sent by the back-end to inform a client application that this alert has been sent to one or more addresses or devices.

What is claimed is:

1. A computer based remote video monitoring system comprising:
a local data transmission system;
a global data transmission system;
a plurality of video input sources, wherein each video input source includes a video capture device configured to create a corresponding video data signal, and wherein the plurality of video input sources are coupled to the local data transmission system;
a control module coupled to the plurality of video input sources via the local data transmission system, wherein the coupling includes the plurality of video data signals, and wherein the control module is data coupled to the global data transmission system; and
a client module indirectly data coupled to the control module through an intermediary data server via the global data transmission system, wherein the indirect data coupling is limited to an outbound data limited communication protocol, and wherein the indirect data coupling is configured to facilitate client module manipulation of control module video management functions including effecting the plurality of video data signals.

2. The system of claim 1, wherein the outbound data limited protocol is an instant messaging protocol.

3. The system of claim 1, wherein the outbound data limited protocol includes outbound limited data transmissions from a sending module including at least one of the control module, client module, and intermediary data server, to a receiving module including at least one of the control module, client module, and intermediary data server.

4. The system of claim 1, wherein the outbound data limited protocol is XMPP.

5. The system of claim 1, wherein the control module is a multi-use computing platform including a video monitoring software module, and wherein the control module's coupling to the plurality of video input sources is managed by the video monitoring software module, and wherein the control module's indirect data coupling to the client module is managed by the video monitoring software module.

6. The system of claim 1, wherein the client module is a multi-use computing platform including a video monitoring software module, and wherein the client module's indirect data coupling to the control module is managed by the video monitoring software module.

7. The system of claim 1, wherein the client module is a multi-use computing platform including a web browser, and wherein the client module's indirect data coupling to the control module is managed by the web browser.

8. The system of claim 1, wherein the client module is a multi-use computing platform data coupled to the control module via the local data transmission system and the global data transmission system.

9. The system of claim 1, wherein the intermediary data server is configured to authenticate the client module and the control module to establish the indirect data coupling.

10. The system of claim 1, wherein the intermediary data server is configured to encrypt and decrypt the indirect data coupling data transmissions.

11. The system of claim 1, wherein the local data transmission system is a local area network including at least one multi-use computing platform.

12. The system of claim 1, wherein the global data transmission system is the Internet.

13. The system of claim 1, wherein the local data transmission system is the same as the global data transmission system.

14. A computer based remote video monitoring system comprising:
a local data transmission system, wherein the local data transmission system is a local area network;
a global data transmission system, wherein the global data transmission system is the Internet;
a plurality of video input sources, wherein each video input source includes a video capture device configured to create a corresponding video data signal, and wherein the plurality of video input sources are coupled to the local data transmission system;
a control module coupled to the plurality of video input sources via the local data transmission system, wherein the coupling includes the plurality of video data signals, wherein the control module is data coupled to the global data transmission system, and wherein the control module is a multi-use computing platform including a video monitoring software module, and wherein the control module's indirect data coupling to the client module is managed by the video monitoring software module; and
a client module indirectly data coupled to the control module through an intermediary data server via the global data transmission system, wherein the indirect data coupling is limited to an outbound data limited communication protocol, and wherein the indirect data coupling is configured enable the client module to manipulate control functions of the control module including effecting the plurality of video data signals, and wherein the client module is a multi-use computing platform including a web browser, and wherein the client module's indirect data coupling to the control module is managed by the web browser.

15. An intermediary data server method for facilitating an indirect data coupling between a video monitoring system control module and a remote client module to enable remote control functionality, comprising the acts of:
receiving a one-way data communication from a video monitoring system control module including an initiation;
receiving a one-way data communication from a remote client module including an initiation;
if the received one-way communications from the remote client module and video monitoring system control module properly correspond with one another, initiating an outbound data limited coupling between the video monitoring system control module and the remote client module and subsequently performing the acts comprising:
receiving a one-way data communication from a remote client module including a request;
transmitting a one-way data communication to a video monitoring system control module including the request;
receiving a one-way data communication from to a video monitoring system control module including a request response; and
transmitting a one-way data communication to a remote client module including the request response;

16. The method of claim 15, wherein a request includes at least one of a control request, a status request, a messaging request, and a data request.

17. The method of claim 15, wherein a request response includes at least one of a control response, a status response, a messaging response, and a data response.

18. The method of claim 15, wherein an initiation includes at least one of presence, authentication, and registration.

19. The method of claim 15, wherein the acts subsequently performed after initiating the outbound data limited coupling further includes:
receiving a one-way data communication from to a video monitoring system control module including a notification; and
transmitting a one-way data communication to a remote client module including the notification.

20. The method of claim 19, wherein a notification includes at least one of a video state change notification, a presence notification, a data transfer status notification, and an alert notification.
